(19) United States
(12) Patent Application Publication
(10) Pub. No.: US 2007/0113535 A1
(43) Pub. Date: May 24, 2007

(54) Dual-plasma-fusion jet thrusters using DC turbo-contacting generator as its electrical power source

(75) Inventors: James ShihFu Shiao, Stow, OH (US); Albert Shih Yung Shiao, Stow, OH (US); Frank ShihChiang Shiao, Stow, OH (US); Tim TsungMin Hung, Stow, OH (US)

Correspondence Address: PATENT, COPYRIGHT & TRADEMARK LAW GROUP, 430 WHITE POND DRIVE, SUITE 200, AKRON, OH, 44320, US

(73) Assignee: Daw Shien Scientific Research & Development, Inc.

(21) Appl. No.: 11/472,517

(22) Filed: Jun. 12, 2006

Related U.S. Application Data
(63) Continuation of application No. 10/929,023, filed on Aug. 30, 2004.

(51) Int. Cl. F03H 1/00

(52) U.S. Cl. 60/203.1; 60/204

(57) ABSTRACT

New [GerTh-DawShien. V] dual-plasma flying object and [GerTh-DawShien. VI] dual-plasma-fusion flying object provide the electric start system to start their warm-up process to their steady-states, automatically. After their warm-up processes done and the operation conditions reached, the [Thruster V] & [Thruster VI] will run themselves, independently by continuously supplying fuel, oxygen, and moisture into the units. Their electrical power will be generated from the [ShihHwa. V] DC turbo-contacting generator by different material-made surfaces and rollers contacting reaction and then, its electricity supplies transform gases from their molecular forms into ionized forms by electrifying reaction. When dual plasmas are fast ejected from nozzles into the ‘C’ shaped magnet's opening, their current will be increasing and plasmas will be bent downward, according to the right hand rule. The linear upward reaction thrust is generated. Thereafter, the plasmas combustion, neutralization, and fusion reactions are conducted also to the action direction and their reaction force for propelling the flying object in the opposite linear guided motion, upward and forward.

### RELATED APPLICATIONS

The present invention is a Continuation in Part of U.S. Ser. No. 10/929,023 filed on Aug. 30, 2004, which a Continuation in Par was U.S. Ser. No. 10/970,152, filed on Oct. 22, 2004, 2004, and both incorporated by reference herein as if fully rewritten.

### BACKGROUND OF THE INVENTION

1. Field of the Invention

The present invention relates generally using DC turbo-contacting generator to electrifying-gases-to-plasmas methods for power and, more particularly to a method of generating useful linear thrust with utilizing dual-plasma, positively and negatively charge-coupled plasmas, which are passed through the latitudinal opening space from opposite sides of a “C” shaped magnet. Plasmas are bent downward according to the electromagnetic right-hand rule, and combusted and neutralized in the combustion space thereafter. And their flue gas (steam) runs turbines which lead to rotate one outer metal surface in one direction and another plastic surface lined with metal surface inside rotate to the opposite direction with some contacting rollers in between, which generate high-power DC electricity to sustain their next processing cycle's electrifying-plasmas power and thrust demands.

2. Background of the Invention

In recent years, the conventional single plasma thrusters have generated some current density with a jerky motion which results in less efficiency and requires more physical space. The dual-plasma (‘+&−’ electrified-plasmas) thruster's process provides improvements and advantages over conventional thruster's problems of relating to the conversion of its single-plasma into electric propulsion with difficult abrupt (jerky) displacement and its jetting power is truely coming from arc's thermal jetting energy, but not from their electromagnetic propulsion.

A search of the prior art did not disclose any patent that reads directly on the claims of the present invention; however, the following references were considered relating and relevant to the present invention:

U.S. Pat. Nos. 6,029,438 and 6,182,441, each issued in the name of Hosick, disclosed a drive circuit for electric propulsion thruster;

U.S. Pat. No. 6,293,090, issued in the name of Olson, disclosed a radio frequency plasma thruster for use in electric propulsion spacecraft, the thruster heating single-plasma in a magnetic field and producing axial thrust, not greatly increasing the efficiency of the RF plasma thruster compared to other thrusters;

U.S. Pat. No. 6,478,257, issued in the name of Oh et al., disclosed a phase change material such as HDPE to have heater or thermal control for electric propulsion devices (thrusters);

U.S. Pat. No. 6,541,916, issued in the name of Decker, disclosed a method and circuit for providing power distribution to electric propulsion thrusters;

U.S. Pat. No. 6,644,014, issued in the name of Provitola, disclosed an electric thruster and thrust augmenter which is intaken or compressed atmospheric gas or reaction thruster exhaust is passed through a gap space between electrodes so that the atmospheric or rection thrust exhaust gases are subjected to an electric current of sufficient intensity.

U.S. Pat. No. 6,609,363, issued in the name of Dressler et al., disclosed single-iodine-plasma electric propulsion thrusters, wherein a heated tank containing iodine crystals is converted into a gaseous propellant;

U.S. Pat. No. 6,651,597, issued in the name of Daniel et al., disclosed a plasmatron having an air jacket, the plasmatron reforming hydrocarbon fuels so as to produce reformed gas further supplied to a remote device such as an internal combustion engine or fuel cell;

U.S. Pat. No. 6,745,466, & U.S. Pat. No. 7,003,941, issued in the names of Fryre, et. Al, disclosed a thruster device comprises a frustoconical inner layer and a frustoconical outer layer that surrounds the inner layer such that the inner and outer layers cooperate to define a spiral flow passage therebetween.

U.S. Pat. No. 6,755,378, issued in the names of Capozzi, et. Al., disclosed a system and method for controlling a propulsion system of a space-borne object.

U.S. Pat. No. 6,786,035, issued in the name of Stickelmaier, disclosed a method and device for clearing an ion thruster grid of contaminants.

U.S. Pat. No. 6,986,497, issued in the names of Starken, disclosed a thruster gas control mechanism for controlling a flow of thrust gas through a gas nozzle.

U.S. Pat. No. 6,996,972, issued in the name of Song, disclosed a method of ionizing a liquid propellant.

U.S. Pat. No. 7,003,942, issued in the names of Le Helley, et. Al., disclosed an invention provides a system for passively controlling pressure oscillations of hydrodynamic origin in a solid propellant thruster.

### SUMMARY OF THE INVENTION

It is the present invention to utilize dual-plasma streams, one of a positive charge and one of a negative charge, in which the streams are electrified by high-voltage DC source and these (+&−) plasmas run toward each other from opposite sides along the latitudinal opening of the C-shaped magnet, thereby generating linear electromagnetic action force and reaction movements according to the right hand rule.

An advantage of the present invention is that a higher thrust and higher power density of dual-plasma can be achieved, and therefore less propellant and less physical space being needed.

Another advantage of the present invention is its DC electricity is generated by high-power DC turbo-contacting generator which modifies to the conventional Van de Graaff contacting generator.

Yet another advantage of the present invention is the inclusion of an electric start system for providing a “warm-up” process for this unit. Before this unit is self-sustaining in replenishing the fuel, oxygen, and humidity, battery's power is provided to rotate dual-outer-contacting surfaces and rollers generating electricity, which is using for electrifying plasmas and then those plasmas running through nozzles increasing the current of plasmas into a “C” shaped electromagnet opening space.

Yet another advantage of the present DC contacting generator invention is with the dual-most-outer moving surfaces rotating oppositely, which are led by turbines. Those dual-outer surfaces can have the most contacting surface area and fast velocities to generate high-power DC electricity by contacting rollers in-between those dual-outer surfaces as the modified contacting method to the Van de Graaff contacting generator. Therefore, the present invention is a reliable high-power device.

Yet another advantage of the present invention is the high power density of dual-plasma generated by this high-power DC turbo-contacting generator having lighter weight in comparison to the traditional high-power DC generator, thereby its increasing power and lighter weight make it easy to fly up with enhancing efficiency of using less propellant.

Yet another advantage of the present invention is the higher operation temperature range (2,200° C.-2,700° C.) at which the dual-plasma flying object's turbines operate, thereby generating the higher power of DC electricity by contacting two oppositely-rotated surfaces with different material-made rollers in-between, and further with no heavy armature or stator of the conventional electromagnetic DC generators.

In one innovation of the present invention, a new dual-plasma flying object having a “C-shaped” magnet for generating thrusting force is provided to generate a linear motion for use in airplane, space craft or other mobile craft for pushing them forward and upward.

Electrical power is needed for starting this [GerTh-DawShien. V] flying object's (Thruster V) two-outer contacting surfaces with rollers in-between to rotating by batteries, and the contacting surfaces will generate high-power DC after the dual-contacting surface reaching to their steady-states, then the next cycle's fuel supplies are electrified and transformed them from molecular forms into ionizing forms. The electrifying plasma streams are squeezed out fast from ionizing chamber nozzles, plasmas attracting toward each other, and ejected out from opposite sides into the latitudinal opening of the “C” shaped magnet generating the action plasmas bent-down force and the reaction lifting thrust. And then, combustion and neutralization are conducted also with the action force direction according to the right hand rule and enhancing guided linear reaction motion. The exhaustion stream sustains its turbines power demands for the next electricity generation cycle by leading two-outer contacting surfaces rotating-oppositely in stable ways.

### DESCRIPTION OF THE PREFERRED INNOVATIONS

The advantages and the present invention will become better understood with referencing to the following more detailed descriptions and claims taken in conjunction with the accompanying drawings, in which like elements are identified with like symbols, and in which:

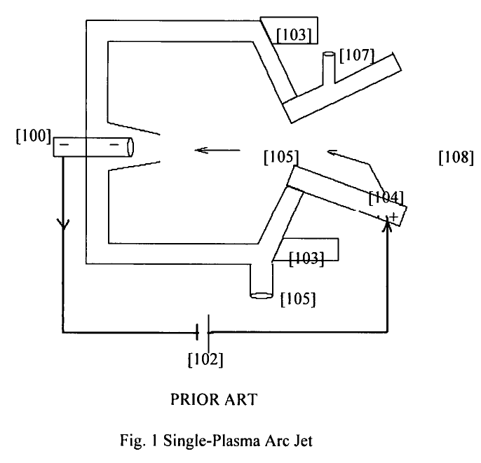

FIG. 1, is a schematic diagram of a conventional single (one) plasma arc jet according to the PRIOR ART;

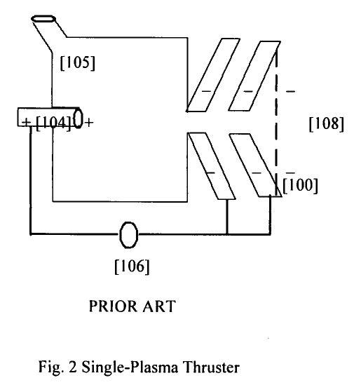

FIG. 2, is a schematic diagram of a conventional single (one) plasma thruster according to the PRIOR ART;

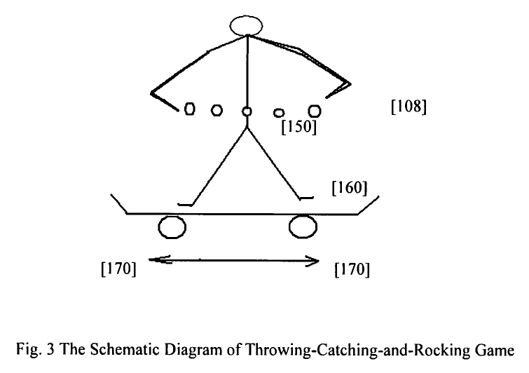

FIG. 3, Is a schematic illustration of the slowing abrupt (jerky) motion of a boy standing on the skating board and playing electrical balls with throwing-catching-missing games between his hands;

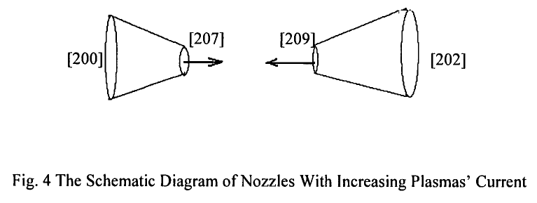

FIG. 4, is a schematic illustration of the nozzles jetting the dual-plasma out from both sides increasing their electric current amount in useful ways;

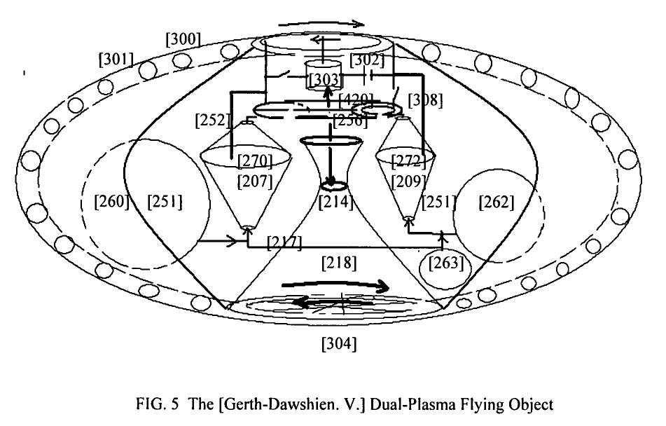

FIG. 5, is a schematic diagram of the Fifth [GerTh-DawShien. V] dual-plasma flying object (referred to as [Thruster V]) including an electric starter means;

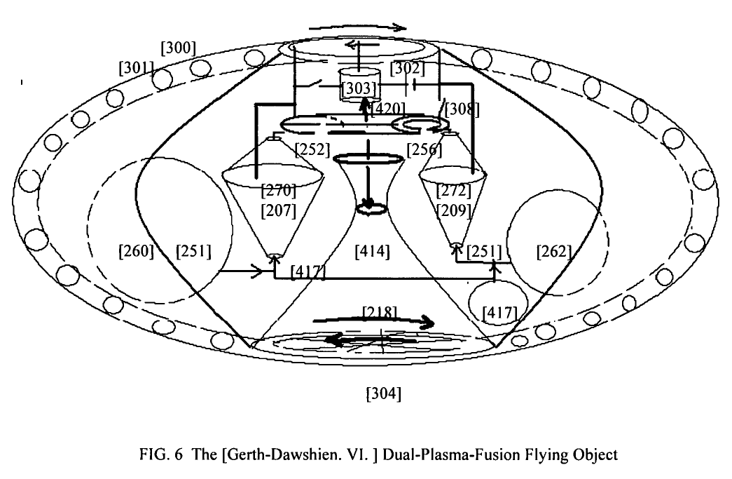

FIG. 6 is a schematic diagram of the Sixth [GerTh-DawShien. VI] dual-plasma-fusion flying object (referred to as [Thruster VI]) with utilizing fuel, oxygen, and dilute heavy water (D₂O) as plasma sources according to a plasmas-fusion innovation of the present Thruster V's invention.

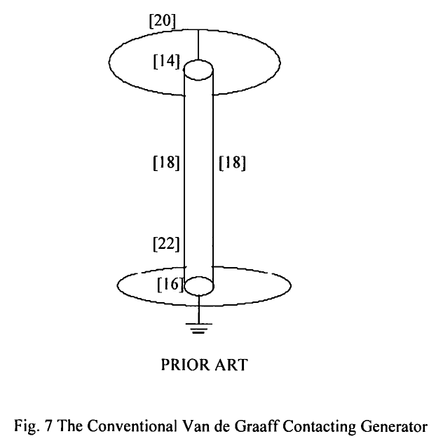

FIG. 7, is a schematic diagram of a conventional Van de Graaff contacting generator according to the PRIOR ART; and

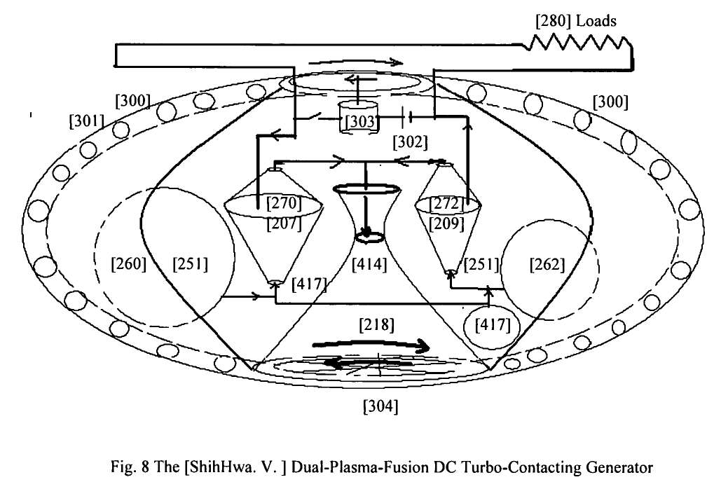

FIG. 8, is a schematic diagram of the new Thruster VI's DC generator (referred to as [ShihHwa. V] dual-plasma-fusion DC turbo-contacting generator) according to the present invention;

### DESCRIPTION OF THE PREFERRED INNOVATIONS

The best mode for describing the invention is presented in terms of its preferred innovations, herein depicted within the FIGS. 1 through 8.

1. Detailed Description of the Figures

Referring now to FIG. 1 and FIG. 2, the conventional single-plasma arc jet and the plasma thruster according to the PRIOR ART are shown here, which broadly describe the principle of generation of thrust when an electrical source is connected through a cathode 100, from a battery 102 and electrons transferred to a charge receiver 105, as propellants, and passed through a magnetic field 103, and then propellants are neutralized at an electrode 104, as an anode, or charges missing target to out-space 108, and the coolant 107 cooled down the shell temperature of the electrifying process, and the throwing-catching-or-missing movements generating little thrust and sustaining in a short time in the prior art.

FIG. 2, the cathode 100 and anode 104 are reversely set up from those of FIG. 1, and has an electric power generator 106 as a substitute for the battery 102 of FIG. 1. The acceleration interaction of this FIG. 2 plasma thruster's electrical field generated through the power generator 106 for the ionized single-plasma 105 accelerating from the anode 104 to the cathodes 100 generates little thrust force as accelerating-neutralizing-missing (as throwing-catching-missing) processes in the prior art. Further, those electric single-plasma processes of charging-neutralizing-missing are not a total closed circuit, which generate an abrupt (jerky) motion for a short displacement and last in a short period of time.

For FIGS. 1 & 2, their main thrust source is still coming from the arc's or the single plasma's thermal jetting power, but not from their electromagnetic force.

FIG. 3, this schematic diagram shows a boy standing on the skating board 160 and playing a throwing-catching-missing game 150 & 108 between his hands. He can throws electric balls 150 between his hands back and forth with miss catching some electric balls 108, that will generate a rocking movement 170 around the origins. And by losing some balls 108, he has some velocity in the opposite direction, and he will also miss some rocking power (fewer balls left 150) to play with.

FIG. 4, is a schematic illustration of the nozzles 207 & 209 jetting the dual-plasma out from both sides 200 & 202 increasing their electric current amount in useful ways. When plasmas passing through nozzles, increasing their velocities into the opening place. Because of nozzles 207 & 209 functioning, there will be more current flow between two nozzles. Those dual-plasma flows are different from the wire current;

FIG. 4, the wire current [I=nevA] and no matter of the wire resistance or the cross-section area: [I₁=n₁e₁v₁A₁]≈[I₂=n₂e₂v₂A₂]. For plasmas gone through nozzles 207 & 209, if A₁>A₂ then v₁<v₂ for keeping the same flow rate in a steady-state flow [v₁A₁=v₂A₂]; then for nozzles' inlet and outlet: electrons' density [n₁<n₂]. If dual-plasma are in higher temperatures, the closer place's electron's charges are higher [e₁<e₂]. The current will be as [I₁=n₁e₁v₁A₁]<<[I₂=n₂e₂v₂A₂].

FIG. 5, a [GerTh-DawShien. V] dual-plasma flying object (referred as [Thruster V]) is provided a high-power DC turbo-contacting generator with contacting surfaces, generally denoted as 300. For warming-up process, two outer-most surfaces are started to rotate by a motor 303 or by turbines 304 which provide any needed initial movements of two-opposite-rotating outer-surfaces 300 that generate high-power DC by its contacting surfaces with different material-made rollers 301. Their generating high-power DC is required to initiate the positive plasma stream 200 and negative plasma stream 202 at the warm up process. A battery 302 allows for this warm-up transition, as an electricity source. From the warm-up process, the contacting generator generates DC power to electrifying plasmas and these continued plasmas will be combusted and neutralized to forming the flue stream 214. After high temperature is attained, the flue stream 214 runs two-opposite-rotating-turbines 304 such that lead the turbo-contacting generator is dual-outer-surface 300 and rollers 301 which generate DC power. Then, their current flow is no more supplied by the battery 302. And their electricity generation of the turbo-contacting generator from the previous thermal combustion heat power 214 and its turbine movements 304 sustain the flying object's power.

After an initial “warm-up” process, in which the unit is permitted to reach and sustain sufficient operating conditions, ensures enough DC power and consistent replenishment of the plasmas, the battery switch 302 is placed in an ‘Charged’ or “off” position. By selectively placing the operation switch 308 in the “on” position, the cable coil 252 is engaged and used to conduct electricity and enhance the electromagnetic field 206 of the magnet 250. Thus, when the sufficient operating high-power DC electricity is attained, plasmas generation and usage are consistently generated from the electrifying process through a continuous supply of fuel 260, oxygen 262, and steam 217. As such, the unit will generate consistent electromagnetic reaction force (thrust) by using plasmas fast passing through nozzles to the “C” shaped electromagnet 250 from the opposite directions. According to the right hand rule, plasmas will be bent downward, which will generate reaction lifting thrust to push the flying object upward or forward in a powerful linear manner.

FIG. 5, shows the general design of a schematic diagram of the Fifth [GerTh-DawShien. V] dual-plasma flying object (referred as [Thruster V]) in which the electrodes 270 & 272 and cables connected to the high-power DC source surfaces 300. Then dual plasmas are fast passing through nozzles to an opening end of the C-shaped electromagnet 250 (and magnetic field 206) vertically from opposite sides to generate an action force 214 according to the right-hand rule. And the interaction of the electromagnetic field 206 is the “C” shaped magnet 250 with the ionized plasmas 207 and 209. This lighter weight [GerTh-DawShien. V] dual-plasma flying object will have more reaction thrust and acceleration with no abrupt (jerky) motion.

Other improvements in the generation of thrust in utilizing a dual positive and negative plasma streams are shown in which the neutralization and combustion generate sparks and heat 214, in which this heat source can be utilized to run turbines 304 which lead two-opposite-rotating-outer-surfaces to rotate for generating high-power DC electricity and their electricity will be used for ionizing plasmas in (+&−) ionizing chambers 207 & 209, separately. By comparison of this new [GerTh-DawShien. V] dual-plasma flying object to the conventional single-plasma arc jet's and the single-plasma thruster, it changes single-plasma's internal implicit force as shown in FIGS. 1, 2, 3, & 4, to generate of more thrust of this invention and getting through the duel-plasma's electromagnetic explicit force. When dual-plasmas passing through nozzles increasing their velocities and current into the opening of the C-shaped magnet and jetting out, they will generate more reaction thrust 420 which is much greater than in the prior art.

More specifically, FIG. 5 depicts a lighter weight dual-plasma flying object comprising heat exchangers 211 and 213 coupled to the electric insulated 251 fuel, oxygen, and water storage tanks 260, 262, & 263 which are supplying fuel 260 and oxygen 262 through humidity injected 217 to the thruster's chambers. Fuel and oxygen are delivered from the electric insulated 251 tanks 260 and 262 through heat exchangers 211 and 213 and humidity injection 217 ready for ionization 207 and 209 of the fuel and oxygen into plasma streams 200 and 202. In this innovation. The plasmas are humidity injected 217 for having better electric conductivities. Electrodes 270 and 272 are provided within the ionizing chambers 207 and 209, which are at opposite sides and are adjacent to the insulted C-shaped magnet 250. The fuel storage tanks 260 and 262, are electrically well insulated 251.

The combustion and neutralization processes occur at the combustion space 214 of this flying object. The high pressure combustion waste 214 generated by this unit is released through a bottom nozzle 218 provided at bottom of the unit, which acts similarly to a jetting nozzle process for making more lifting thrust.

The magnet 250 has cable coil 252 wound about the magnet external surface to generate concurrent electromagnetic fields about the magnet 250. The cable 252 is oil cooled for extending the life of the unit and optimizing operating insulation conditions 251. The magnet 250 may include ceramic insulation 251 to protect and/or optimize the electromagnetic field generated by the cable coil 252.

Referring now to FIG. 6, a schematic diagram of the Sixth [GerTh-DawShien. VI] dual-plasma-fusion flying object (referred as [Thruster VI]) by utilizing diluted heavy water injected 417 into ionizing chambers 207 and 209, is depicted in accordance to an alternate plasma-fusion innovation to the present [Thruster V] invention. In this plasma-fusion innovation, as compared to an exemplary innovation described by FIG. 6, diluted heavy water 417, plasmas 200, and 202 are electrified at the [Thruster VI] ionizing chambers 207 & 209, respectively. The high-power DC generator 300 provides a continuous flow of charges to each electrode 270, 272. The two-outer-surfaces 300 are made of metal and plastic, separately. The rollers 301 are metallic, or other suitable material-made and shaped to have increased surface contacting area. In this, the positively charged hydrogen plasma with ‘+’ charged heavy water [2H⁺;D₂O⁺] and negatively charged oxygen plasma with ‘−’ charged heavy water [O⁼;D₂O⁻] of FIG. 6, and are same passed through a “C” shaped magnet's 250 latitudinal opening 254, such that generate an action plasmas-bent-down force 414 according to the right hand rule, and a reacting lifting-up thrust 420 as in FIG. 6.

Finally, the [GerTh-DawShien. VI] dual-plasma-fusion flying object's innovation as shown in FIG. 6 has a nuclear diluted ‘+&−’ heavy water fusion reaction 414 which also provides more power to turbines for generating more electricity and the flying thrust 420. Because of its having more power and less weight, less amount of propellant is needed. The fusion energy and combustion heat 414 are released and directed through a bottom nozzle 218 of this invention, as its jetting power to increase its reaction thrust 420 and running turbines 304.

Referring now to FIG. 7, a schematic diagram of a conventional Van de Graaff generator according to the PRIOR ART is shown broadly describing the generation of electric power. The conventional Van de Graaff generator is a high-voltage DC generator in which the contacting-surfaces 14 & 16 of this generator are directly converting the different-material-contacting movements into electricity by means of rollers and belt rotating process 18. The brushes 14 and 16, are continuously transport charges to the two (+&−) terminals of the generator, anode 20 and cathode 22. This conventional Van de Graaff generator process takes place in the room temperature ranges of 15° C. to 25° C., but if happening at high temperatures, charges run more wildly and the risk of discharging sparks increased.

FIG. 8, For the new advanced Thruster VI's DC generator is referred as ([ShihHwa. V] dual-plasma-fusion DC turbo-contacting generator). For purposes of disclosure, and not as a limitation, and for purposes of providing a disclosure under 35 U.S.C. 112, as [Thruster VI] by utilizing diluted heavy water injected 417 into ionizing chambers 207 and 209, is depicted in accordance to an alternate plasma-fusion innovation to the present [Thruster V] invention. In this plasma-fusion power generation innovation, as compared to an exemplary innovation described by FIG. 8, diluted heavy water 417, plasmas 207, and 209 are electrified at the chambers, respectively. The high-power DC contacting-generator 300 provides a continuous flow of charges to each electrode 270, 272, respectively. The two-outer-surfaces 300 are made of metal and plastic, separately. The rollers 301 are metallic or plastic, or other suitable material shaped to have increased surface contacting area. In this, the positively charged hydrogen plasma with ‘+’ charged heavy water and negatively charged oxygen plasma with ‘−’ charged heavy water are generated from electrifying of FIG. 8.

Finally, the innovation as shown has a nuclear diluted ‘+&−’ heavy water fusion reaction 414 which also provides more thermal power to turbines for generating more electricity, and less amount of non-fusion propellant is needed. The fusion energy and combustion heat 414 are released and directed through a nozzle 218 to run turbines 304 and rotate two power generation surfaces 300 of this invention. The dual-plasma-fusion reactions of this innovation are:

Positive Electrode side: [2H⁺+D₂O⁺];
H₂+D₂O+‘+’charged+Cable→[2H⁺+D₂O⁺]+3e⁻+3‘+’→→[2H⁺+D₂O⁺]
Negative Electrode side: [O⁼+D₂O⁻]; O₂+2D₂O+Cable+6e⁻(electron flow)→2[O⁼+D₂O⁻]
The equations are shown as: Combustion, Neutralization, & Fusion Reactions:

$$[ 2 {H}^{+} ; {D}_{2} {O}^{+} ] + [ {O}^{=} ; {D}_{2} {O}^{-} ] \to [ H \text{-} O \text{-} H ] Steam + 2 {He}^{+ 2} [ α particles ] + {20}^{=} \to [ H \text{-} O \text{-} H ] Steam + 2 He [ no charge / no radiation ] + 20 + fusion heat runs turbo \text{-} contacting generator + dynamic \text{-} plasma generate lifting \text{-} force \text{-} of \text{-} {thruster}^{′} s$$

2. Operation of the Preferred Innovations

In accordance with the preferred innovations, the various features of the present invention are summarized in Table 1 below.

TABLE 1
The Similarities & Differences Among [GerTh-DawShien. V & VI] Jet
Thrusters And [ShihHwa. V] DC Turbo-Contacting Generator.

| | [GerTh- | [GerTh- | |
|---|---|---|---|
| | DawShien] | DawShien] | [ShihHwa. V] |
| Classification | [Thruster V] | [Thruster VI] | [DC generator] |
| Electric Start | Yes | Yes | Yes |
| Electric Running | Yes | Yes | Yes |
| Thermal Energy Run | Yes | Yes | Yes |
| Generate Electricity | Yes | Yes | Yes |
| Taken Electric Loads | Yes | Yes | Yes |
| With “C” shaped | Yes | Yes | No |
| Electromagnet | | | |
| Generate Motion | Yes | Yes | No |
| ‘+’ Plasmas | H⁺; (H₂O⁺) | H⁺; (D₂O⁺) | H⁺; (D₂O⁺) ions |
| | ions | ions | |
| ‘−’ Plasmas | O⁼; (H₂O⁻) | O⁼; (D₂O⁻) | O⁼; (D₂O⁻) ions |
| | ions | ions | |
| Plasmas-Fusion | No | Yes | Yes |

The foregoing descriptions of specific innovations of the present invention are presented for purposes of illustration and application. They are not intended to be exhaustive or to limit the invention to the precise forms disclosed, and obviously many modifications and variations are possible in light of the above disclosure. The innovations were chosen and described in order to best explain the motion principles of the dual-plasma jet thruster V & dual-plasma-fusion jet thruster VI and their practical applications, to thereby enabling others skilled in the art with various advanced modifications as those are suited to the particular use contemplatively. It is intended that the scope of the invention are defined by the Claims appended hereto and their equivalents. Therefore, the scope of the invention is to be limited only by the following claims.

What claimed are:

1. A method for generating propulsion of a flying object comprising the steps of:
a. generating dual-plasma fuel and oxygen in ionization chambers;
b. generation more current from plasmas flowing through nozzles into a ‘C’ shaped electromagnet;
c. generating an electromagnetic action force downward by transporting said fuel and oxygen through a ‘C’ shaped electromagnet; and
d. generating combustion, neutralization, and fusion reaction force for auxiliary propelling said flying object.

2. The method of claim 1, wherein said magnet comprises:
a C-shape forming a latitudinal opening; and
a cable coil wound about said magnet coupled to an electrical source for enhancing the electromagnetic field about said latitudinal opening.

3. The method of claim 1, wherein said plasma flows are accelerated through nozzles and plasmas are shooting into the opening of a ‘C’ shaped electromagnet increasing their current flow and action power.

4. The method of claim 1, wherein said fuel, oxygen, and dilute heavy water are stored in separate insulated tanks.

5. The method of claim 1, wherein combustion generates an action force in the direction of the combustion discharge and a reaction force in the opposite direction, thereby enhances propelling said flying object in the same direction of the reaction force.

6. The method of claim 1, wherein said plasmas pass through said ‘C’ shaped magnet such as to generate an action force downward in the direction of the plasmas discharge, neutralization, and fusion and a reaction lifting-up force in the opposite direction, thereby propelling said flying object in the direction of said reaction force.

7. The method of claim 1, wherein said plasma flowing through said central nozzle further comprises turbines disposed posterior to said nozzle, said turbines leading two-outer-surfaces contacting with different material-made rollers and rotating in opposite directions generating the contacting dc power.

8. The methods of claim 1, wherein said methods are used for providing at least one plasma thruster for the [GerTh-DawShien. V] dual-plasma flying object and the [GerTh-DawShien. VI] dual-plasma-fusion flying object.

9. The plasmas thrusters of claim 8, wherein said plasma fuel source appliance comprises a high-temperature humidity injector and generation for the diluted heavy water humid fuel and oxygen for better plasmas' conduction properties and the fusion reaction, afterward.

10. The plasmas thrusters of claim 8, wherein said electrodes are made of a material to increase their high-temperature resistance and keep the constant electric conducting surface selected from the group comprising: Tantalum (Ta);
and Molybdenum (Mo).

11. The [GerTh-DawShien. VI] method of claim 8, wherein said plasmas are generated by electrifying the diluted heavy water humid fuel and oxygen via electrodes.

12. The [ShihHwa. V] dual-plasma-fusion DC Turbo-contacting generator comprising:
a fuel source having one ionizable fuel and oxygen;
a pair of ionization chambers, each one of said chambers coupled to receive one of said plasma fuel and oxygen, respectively;
a central nozzle and turbines in it, this said portal increasing the flue gas power to run said turbines and dual-outer-contacting-surfaces generating high-power DC;
a space disposed between said chambers for combustion of said fuel and oxygen; and
a nozzle for discharging the combustion exhaustion;
wherein the combustion of said ionized fuel and oxygen generating thermal energy to run turbines for generating DC electricity and initializing the next plasmas-generation cycle.

13. The generator of claim 12, wherein said fuel source comprises the fuel, oxygen, and dilute heavy water tanks, separately, and electrically well insulated.

14. The generator of claim 12, wherein one of said plasma fuel is hydrogen saturated with ‘+’ diluted heavy water vapor, thereby allowing for easier electrical conducting and its charge coupled fusion reaction happened possible.

15. The generator of claim 12, wherein one of said plasma is oxygen saturated with ‘−’ diluted heavy water vapor, thereby allowing for easier electrical conducting and its charge coupled fusion reaction happened possible.

16. The generator of claim 12, wherein said cable conducts electricity generated from said DC contacting generator of supporting electrical loads, or its electricity can be used for municipal fusion-electrical power demands.

17. The generator of claim 12 for use in the Thruster VI, further comprising:
at least one electro-magnet disposed between said chambers, said magnet generating a magnetic field as for the Thruster VI's uses;
a space disposed between said chambers and posterior to said magnet, said space for combustion of said fuel and oxygen; and
a central nozzle for discharging combustion exhaustion and running turbines for generating DC electricity, totally from this DC turbo-contacting generator.

18. A method for the DC turbo-contacting generator's generation of an electrical current comprising the steps of:
a. electrifying fuel and oxygen in ionization chambers;
b. ionizing said fuel and oxygen by electrifying reaction within said chambers;
c. transporting said fuel and oxygen into a combustion, neutralizing, and fusion reaction space disposed between said chambers, said unlike-charged plasma fuel and oxygen ions attracting and accelerating toward each other to increase its current;
d. combusting said fuel and oxygen for generating thermal energy;
wherein said thermal energy heat of said flue gas for sustaining turbo-contacting generator generating electricity, which ionizing said fuel and oxygen in the next cycle, which can also generate electric power for the municipal's fusion-electricity power demands and loads.

19. The method of claim 18, wherein said dual-plasma-fusion generates as a fused-electrical current from the dual-surface and contacting rollers' movement without having heavier armature and stator, and which will be the future municipal's lighter mass power source generator for more power density.
